(19) United States
(12) Patent Application Publication
(10) Pub. No.: US 2008/0151965 A1
(43) Pub. Date: Jun. 26, 2008

(54) DISPLAY APPARATUS AND COLOR TEMPERATURE CONTROL METHOD THEREOF

(75) Inventor: Young-kook Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/964,081

(22) Filed: Dec. 26, 2007

(30) Foreign Application Priority Data
Dec. 22, 2006 (KR) 10-2006-0133023

(51) Int. Cl. G01K 11/12

(52) U.S. Cl. 374/162; 374/E11.018

(57) ABSTRACT

Disclosed is a display apparatus including: a display panel which displays an image based on a video signal; a backlight unit which includes a plurality of light emitting diodes to emit a light to respective regions of the display panel; a sensor which senses a color temperature of the image which is displayed to the display panel; and a controller which transmits information about the color temperature sensed by the sensor to an external host apparatus and adjusts amount of current to be supplied to each light emitting diode on the basis of a result value corresponding to a target color temperature received from the external host apparatus. With this configuration, the color temperature is precisely adjusted regardless of deviation in products.

### CROSS-REFERENCE TO RELATED APPLICATIONS

This application claims priority from Korean Patent Application No. 10-2006-0133023, filed on Dec. 22, 2006, in the Korean Intellectual Property Office, the disclosure of which is incorporated herein by reference.

### BACKGROUND OF INVENTION

1. Field of Invention

A display apparatus and a control method thereof consistent with the present invention relate to adjustment of a color temperature.

2. Description of the Related Art

Generally, a display apparatus displays an image depending on a video signal. A display apparatus such as a liquid crystal display (LCD) or the like includes a color panel outputting RGB colors, and a backlight unit emitting light to the color panel to output an image.

The display apparatus differently expresses a color tone of image according to property of a color temperature. Here, the color temperature refers to the temperature of light by a complete heat radiation. If the color temperature is high, a blue color tone increases, and if the color temperature is low, a red color tone increases.

Here, a user may display the image with a wanted color tone by inputting the color temperature through an on screen display (OSD), etc. The color temperature may be measured by using two dimensional color coordinate value corresponding to light through a sensor provided to the backlight unit.

However, the color temperature becomes decreased if the backlight unit is used for a long time, and is different by a manufacturer. Also, an image is displayed to have the color temperature different from a color temperature intended by a user due to the position of a calorimeter for measuring the color temperature, distance between the backlight unit and the sensor, property of the panel, etc.

A conventional display apparatus changes the color of the video signal to correct a measured color temperature to the target color temperature. Here, the video signal is distorted according to the changing of the color temperature.

### SUMMARY OF THE INVENTION

Accordingly, it is an aspect of the present invention to provide a display apparatus and a color temperature control method thereof adjusting the amount of light emitted by a backlight unit according to difference between a color temperature measured by a calorimeter and a target color temperature, thereby precisely adjusting the color temperature.

The foregoing and/or other aspects of the present invention can be achieved by providing a display apparatus, including: a display panel which displays an image based on a video signal; a backlight unit which includes a plurality of light emitting diodes to emit a light to respective regions of the display panel; a sensor which senses a color temperature of the image which is displayed to the display panel; and a controller which transmits information about the color temperature sensed by the sensor to an external host apparatus and adjusts amount of current to be supplied to each light emitting diode on the basis of a result value corresponding to a target color temperature received from the external host apparatus.

The display apparatus further includes a storing unit which stores a lookup table in which the color temperature and a color coordinate value correspond to each other, wherein the controller transmits the information about the color coordinate corresponding to the sensed color temperature from the lookup table to the external host apparatus, and receives the color coordinate value corresponding to the target color temperature from the external host apparatus.

The controller adjusts the amount of the current so that a difference between the sensed color temperature and the target color temperature can be within a predetermined value.

The display apparatus may further include a user inputting unit, wherein the controller receives the target color temperature by the user inputting unit.

The controller may repeatedly adjust the amount of the current in a range where the color coordinate value nonlinearly increases as the color temperature increases.

The display apparatus may further include a communicating unit, wherein the controller uses the communicating unit to transmit the information about the sensed color temperature to the external host apparatus, and controls the communicating unit to receive the result value corresponding to the target color temperature.

According to an aspect of the invention, a color temperature control method of a display apparatus which includes a display panel which displays an image based on a video signal, and a backlight unit which includes a plurality of light emitting diodes to emit a light to respective regions of the display panel, includes: sensing a color temperature of the image which is displayed on the display panel; transmitting information about the sensed color temperature to an external host apparatus; receiving a result value corresponding to a target color temperature from the external host apparatus; and adjusting the amount of current to be supplied to each light emitting diode according to the received result value.

The transmitting the information of the color temperature includes transmitting information about a color coordinate corresponding to the sensed color temperature on the basis of a lookup table where the color temperature corresponds to the color coordinate, and the receiving the result value corresponding to the target color temperature includes the color coordinate corresponding to the target color temperature.

The adjusting the amount of the current includes adjusting the amount of the current so that difference between the sensed color temperature and the target color temperature can be within a predetermined value.

The target color temperature is inputted by a user.

The adjusting the amount of the backlight unit includes repeatedly adjusting the amount of the current in a range where the color coordinate value nonlinearly increases as the color temperature increases.

### BRIEF DESCRIPTION OF THE DRAWINGS

The above and/or other aspects of the prevent invention will become apparent and more readily appreciated from the following description of the exemplary embodiments, taken in conjunction with the accompanying drawings, in which:

FIG. 1 is a block diagram illustrating a configuration of a display apparatus according to a first exemplary embodiment of the present invention;

FIG. 2 is a block diagram illustrating a configuration of a display apparatus according to a second exemplary embodiment of the present invention; and

FIG. 3 is a flowchart illustrating a color temperature control method of a display apparatus according to an exemplary embodiment of the present invention.

### DETAILED DESCRIPTION OF EXEMPLARY EMBODIMENTS OF THE INVENTION

Reference will now be made in detail to the embodiments of the present invention, examples of which are illustrated in the accompanying drawings, wherein like reference numerals refer to like elements throughout. The embodiments are described below so as to explain the present invention by referring to the figures.

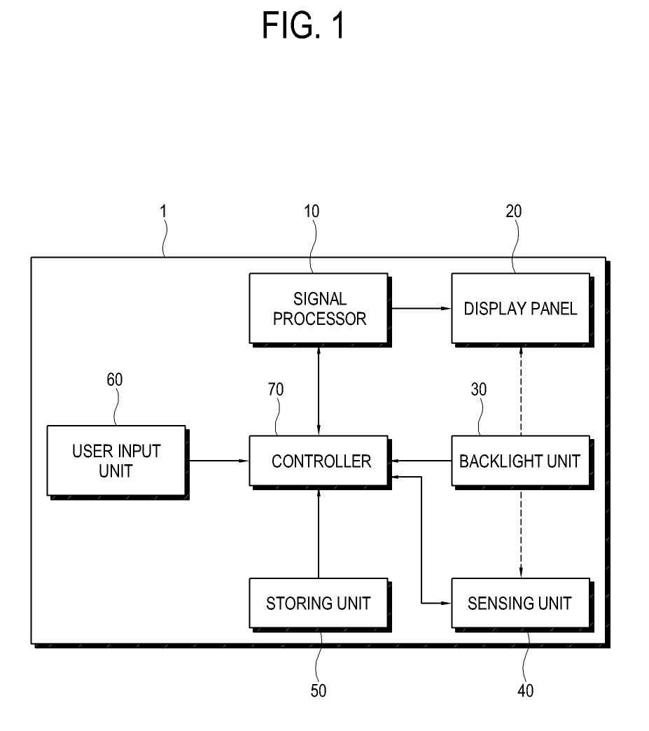

As shown in FIG. 1, a display apparatus 1 according to a first exemplary embodiment of the present invention includes a signal processor 10, a display panel 20, a backlight unit 30, a sensor 40, a storing unit 50, a user inputting unit 60 and a controller 70. The display apparatus 1 according to the present embodiment may be embodied with a liquid crystal display (LCD) monitor including a backlight unit, etc.

The signal processor 10 receives and processes a video signal. Also, the signal processor 10 may perform a decoding for extracting an image information from the inputted video signal, a scaling for adjusting resolution of a decoded image according to property of the display panel 20 and setting of a user, a picture enhancement for improving quality of an image, etc.

The display panel 20 outputs the image by the video signal processed by the signal processor 10. The display panel 20 includes a first substrate (not shown) formed with a switching element (not shown), a pixel electrode, etc., a second substrate (not shown) formed with red (R), green (G) and blue (B) color filters, and a liquid crystal positioned between both substrates. The liquid crystal receives an electrical signal and transmits and blocks a light from the backlight unit 30 to adjust an amount of the light transmitted, thereby displaying an image.

The backlight unit 30 may include a plurality of light emitting diodes (LED) for emitting the light to respective regions of the display panel 20. Also, the backlight unit 30 may emit the light to all regions of the display panel 20. Since the display panel 20 according to the present embodiment does not emit the light by itself, a brightness of the video signal outputted to the display panel 20 is adjusted depending on an amount of the light emitted from the light emitting element provided to the backlight unit 30.

The sensor 40 senses a color temperature of the image outputted to the display panel 20. The sensor 40 according to the present embodiment may include a calorimeter, and calculate a two dimensional color coordinate value having a white color outputted to the display panel 20.

The storing unit 50 stores a lookup table in which color temperatures correspond with color coordinate values, and may include an electrically erasable and programmable read only memory (EEPROM), a flash memory, etc. Here, the color coordinate stored in the lookup table may follow a diagram of commission internationale de l'eclairage (CIE).

Also, the storing unit 50 may store a color coordinate value corresponding to brightness adjusted by the controller 70. Accordingly, it may make a separate calculation adjusting the brightness of the light emitted by the backlight unit 30 unnecessary.

The user inputting unit 60 receives a target color temperature from a user. The user inputting unit 60 according to the present embodiment may be provided to a side of a main body of the display apparatus 1, and may include a wireless remote controller. Alternatively, the user inputting unit 60 may receive the target color temperature from an external host apparatus.

The controller 70 supplies a current to each LED so that the color temperature sensed by the sensor 40 can correspond to the target color temperature, thereby adjusting the brightness of the light emitted by the backlight unit 30. The controller 70 according to the present embodiment may include a main board (not shown) transmitting a color coordinate corresponding to the target color temperature to the backlight unit 30, and a driving driver (not shown) driving the backlight unit 30 to have a predetermined brightness.

Here, the controller 70 may adjust the brightness of light emitted by the backlight unit 30 so that a difference between a color temperature sensed by the sensor 40 and the target color temperature can be within a predetermined value.

The controller 70 adjusts the amount of the current depending on a predetermined reference color coordinate value, and supplies the current to each LED included in the backlight unit 30. The controller 70 may include an IC circuit outputting a PWM control signal for adjusting the amount of the current depending on the color coordinate value to adjust the brightness of light emitted by the backlight unit 30, and it is preferred but not necessary to previously measure to know a PWM frequency needed to raise the luminous amount of the backlight unit 30 by 1 cd/m². Accordingly, the controller 70 may change a frequency of a PWM control signal for an RGB value corresponding to the target color temperature, and performs a feedback about the color temperature value sensed by the sensor 40, thereby precisely adjusting the color temperature.

Hereinafter, an exemplary process that the controller 70 adjusts the brightness of the light emitted by the backlight unit 30 if the target color temperature is 6,500K will be described.

At first, the controller 70 reads color coordinate values x=0.3127 and y=0.329 corresponding to the target color temperature 6,500K from the lookup table stored in the storing unit 50, and then controls the backlight unit 30 to emit the light to the display panel 20.

If the backlight unit 30 emits the light to the display panel 20, the controller 70 senses the color temperature of an image displayed to the display panel 20 through the sensor 40.

Here, the controller 70 reads a color coordinate value corresponding to the color temperature sensed by the sensor 40 from the lookup table stored in the storing unit 50, and compares the read color coordinate value with the color coordinate value corresponding to 6,500K. For example, if the color coordinate values corresponding to the color temperature sensed by the sensor 40 are x=0.3053 and y=0.3216, the controller 70 controls the backlight unit 30 to emit the light to the display panel 20 according to increased result values x=0.3201 and y=0.3364 which are made by adding differences Δx=0.0074 and Δy=0.0074 between the color coordinate values corresponding to the target color temperature and the sensed color coordinate values corresponding to the sensed color temperature.

Here, the controller 70 may adjust the brightness of the light emitted by the backlight unit 30 if the difference between the color coordinate values corresponding to the target color temperature and the color coordinate values sensed by the sensor 40 is not within a predetermined range.

Since an increment of the color coordinate according to an increase of the color temperature is nonlinear in a range of the color temperature more than 7,000K, the controller 70 may adjust the brightness of the light emitted by the backlight unit 30 by repeating the above process in the target color temperature range more than 7,000K.

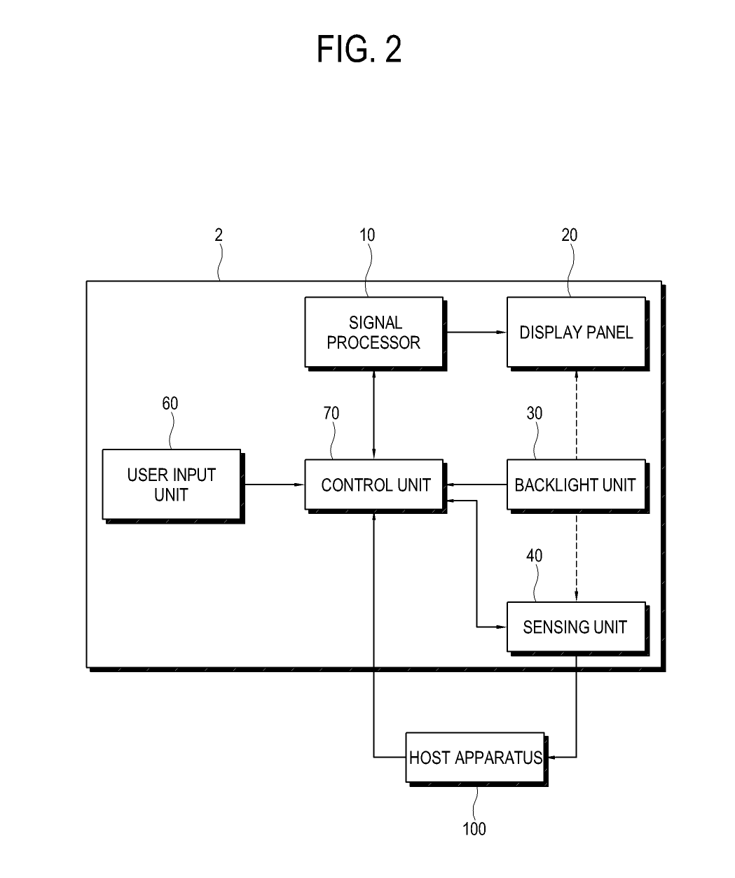

Hereinafter, a display apparatus 2 according to a second exemplary embodiment of the present invention will be described by referring to FIG. 2. As shown in FIG. 2, the display apparatus 2 according to the second exemplary embodiment of the present invention transmits a color temperature value sensed by a sensor 40 to an external host apparatus 100.

Here, the external host apparatus 100 includes a personal computer, etc., that may include a controller, and transmits a color coordinate value corresponding to a brightness of the light emitted by a backlight unit 30 to a controller 70 through a display data channel (DDC) line.

The external host apparatus 100 may store a lookup table in a storing unit, in which the color temperature is corresponded to the color coordinate values by the controller. The external host apparatus 100 may include software calculating the color coordinate values corresponding to the target color temperature in the controller.

The display apparatus 2 according to the second exemplary embodiment of the present invention may include a communicating unit (not shown). The communicating unit communicates the information about the color temperature and the color coordinate with the external host apparatus. The communicating unit may employ a wireless connection such as a wireless local area network (LAN) module as well as a wire connection to perform the communication.

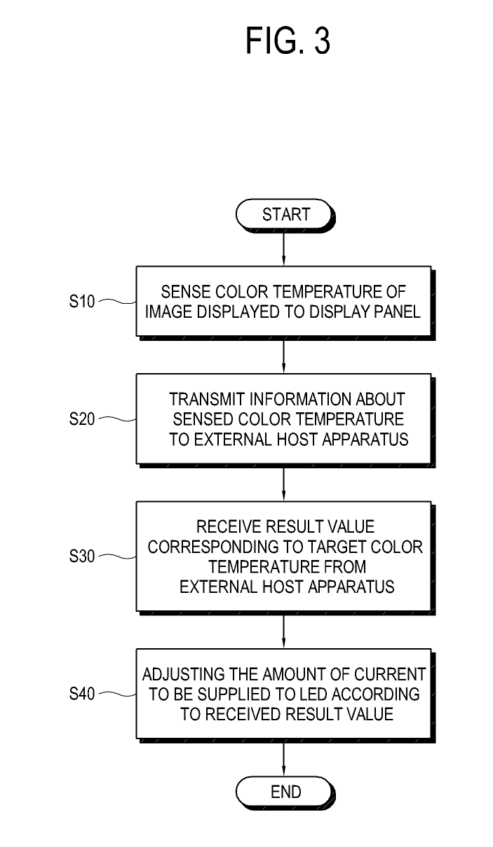

Hereinafter, a color temperature control method of the display apparatus according to an exemplary embodiment of the present invention will be described by referring to FIG. 3.

At first, the controller 70 senses the color temperature of an image displayed to the display panel 20 by the sensor 40 (S10). Then, the controller 70 transmits information about the color temperature sensed at the operation S10 to the external host apparatus 100 (S20), and receives a result value corresponding to the target color temperature from the external host apparatus 100 (S30). Alternatively, at the operation 20, the controller 70 instead of the external host apparatus 100 may calculate color coordinates corresponding to the sensed color temperature and the result value corresponding to the target color temperature on the basis of the lookup table where the color temperature corresponds to the color coordinates.

Then, the controller 70 adjusts the amount of the current to be supplied to each LED on the basis of the value resulting from the operation S30 (S40).

Here, the controller 70 may adjust the amount of the current so that the difference between the sensed color temperature and the target color temperature can be within a predetermined value.

Also, the controller 70 may repeatedly adjust the brightness of the light with respect to the range in which the color coordinate nonlinearly increases as the color temperature increases.

As described above, the present invention provides a display apparatus and a color temperature control method thereof adjusting an amount of a light emitted by a backlight unit according to a difference between a color temperature measured by a calorimeter and a target color temperature, thereby precisely adjusting the color temperature irrespective of deviation by a product.

Also, since a color temperature is adjusted depending on a brightness of a backlight unit, the color temperature can be precisely adjusted without distortion of a video signal.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus, comprising:
a display panel which displays an image based on a video signal;
a backlight unit which comprises a plurality of light emitting diodes emitting light to respective regions of the display panel;
a sensor which senses a color temperature of the image which is displayed on the display panel; and
a controller which transmits information about the sensed color temperature to an external host apparatus and adjusts an amount of current supplied to each of the plurality of light emitting diodes based on a result value corresponding to a target color temperature received from the external host apparatus.

2. The display apparatus according to claim 1 further comprising a storing unit which stores a lookup table in which color temperatures correspond to color coordinate values,
wherein the controller transmits information about a color coordinate corresponding to the sensed color temperature from the lookup table to the external host apparatus, and receives a color coordinate value corresponding to the target color temperature from the external host apparatus.

3. The display apparatus according to claim 1, wherein the controller adjusts the amount of the current so that a difference between the sensed color temperature and the target color temperature is within a predetermined value.

4. The display apparatus according to claim 1, further comprising a user input unit,
wherein the controller receives the target color temperature by the user input unit.

5. The display apparatus according to claim 2, wherein the controller repeatedly adjusts the amount of the current in a range where the color coordinate value nonlinearly increases as the color temperature increases.

6. The display apparatus according to claim 1, further comprising a communicating unit,
wherein the controller uses the communicating unit to transmit the information about the sensed color temperature to the external host apparatus, and controls the communicating unit to receive the result value corresponding to the target color temperature.

7. A color temperature control method of a display apparatus which comprises a display panel which displays an image based on a video signal, and a backlight unit which includes a plurality of light emitting diodes emitting light to respective regions of the display panel, the color temperature control method comprising:
sensing a color temperature of the image which is displayed on the display panel;
transmitting information about the sensed color temperature to an external host apparatus;
receiving a result value corresponding to a target color temperature from the external host apparatus; and
adjusting an amount of current supplied to each of the plurality of light emitting diodes according to the received result value.

8. The color temperature control method of the display apparatus according to claim 7, wherein
the transmitting the information about the sensed color temperature comprises transmitting information about a color coordinate corresponding to the sensed color temperature based on a lookup table where color temperatures correspond to color coordinates, and
the receiving the result value corresponding to the target color temperature comprises receiving a color coordinate corresponding to the target color temperature.

9. The color temperature control method of the display apparatus according to claim 7, wherein the adjusting the amount of the current comprises adjusting the amount of the current so that a difference between the sensed color temperature and the target color temperature is within a predetermined value.

10. The color temperature control method of the display apparatus according to claim 7, wherein the target color temperature is input by a user.

11. The color temperature control method of the display apparatus according to claim 8, wherein the adjusting the amount of the backlight unit comprises repeatedly adjusting the amount of the current in a range where the color coordinate value nonlinearly increases as the color temperature increases.

12. A host apparatus, comprising:
a communicating unit which receives information about a color temperature of an external display apparatus; and
a controller which calculates a result value corresponding to a target color temperature when receiving the information about the color temperature from the external display apparatus and transmits the result value to the external display apparatus through the communicating unit.

13. The host apparatus according to claim 12, further comprising a storing unit which stores a lookup table in which color temperatures correspond to color coordinates,
wherein, when receiving the information about the color temperature from the external display apparatus, the controller determines information about a color coordinate corresponding to the target color temperature based on the lookup table and transmits the information about the color coordinate to the external display apparatus.

14. The host apparatus according to claim 12, further comprising a user input unit, wherein the controller receives the target color temperature from the user input unit.
